(19) United States
(12) Patent Application Publication
(10) Pub. No.: US 2009/0292956 A1
(43) Pub. Date: Nov. 26, 2009

(54) TREND BASED TEST FAILURE PRIORITIZATION

(75) Inventors: Carlo Rivera, Kirkland, WA (US); D. Gordon Hardy, Seattle, WA (US); Patrick Niemeyer, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/125,927

(22) Filed: May 23, 2008

(51) Int. Cl. G06F 11/00

(52) U.S. Cl. 714/48; 714/E11.001

(57) ABSTRACT

Various technologies and techniques are disclosed for using historical trends from prior tests to prioritize how failures are reported in later tests. After a user changes a software development project, one or more tests are run to detect failures during execution of the tests. Any detected failures are analyzed in comparison with historical failures for the software development project across tests run for multiple users. Any detected failures are categorized as new or old. New failures are reported with a different emphasis than old failures, such as with new failures being reported as a higher priority than old failures.

### BACKGROUND

Software developers create software using one or more software development programs. Throughout the software development process, software developers typically test their own code to ensure that it is operating as expected. Furthermore, one or more testers can conduct further testing to ensure that the software program overall operates as expected, and on the various platforms being supported.

For large software projects, there can be multiple software developers writing source code for a given software program. It can be difficult for a given software developer to know whether an error that is occurring during testing resulted from the code he wrote, the code he just changed, or from the code written by one or more of the other developers. As a result, a given software developer often spends a lot of time investigating errors that he did not even cause.

### SUMMARY

Various technologies and techniques are disclosed for using historical trends from prior tests to prioritize how failures are reported in later tests. After a user changes a software development project, one or more tests are run to detect failures during execution of the tests. Any detected failures are analyzed in comparison with historical failures for the software development project across tests run for multiple users. Any detected failures are categorized as new or old. New failures are reported with a different emphasis than old failures, such as with new failures being reported as a higher priority than old failures.

In one implementation, the newness of the error and whether or not it was introduced by the current user helps determine how the error gets reported. Current failure information is gathered from one or more automated tests of a software development application for a current user. Historical failure information is gathered from failures occurring in past automated test runs of the software development application for all users. Current failure information is compared to historical failure information to determine if any failures have occurred in past test runs. Any failures that have not occurred in past automated test runs are reported in a first priority grouping of failures. Any failures that have occurred in past automated test runs for the current user are reported in a second priority grouping of failures. Any failures that have occurred in past automated test runs for other users are reported in a third priority grouping of failures.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a trend based test failure prioritization system of one implementation.

FIG. 2 is a process flow diagram for one implementation illustrating the stages involved in reporting new failures differently than old failures.

FIG. 3 is a process flow diagram for one implementation illustrating the stages involved in prioritizing the way failures are reported based upon multiple criteria.

FIG. 4 is a simulated screen for one implementation that illustrates reporting new failures differently than old failures.

FIG. 5 is a diagrammatic view of a computer system of one implementation.

### DETAILED DESCRIPTION

The technologies and techniques herein may be described in the general context as an application that prioritizes failures from tests based upon historical trends, but the technologies and techniques also serve other purposes in addition to these. In one implementation, one or more of the techniques described herein can be implemented as features within a software development program such as MICROSOFT® Visual Studio, or from any other type of program or service that performs testing and/or reporting of software test runs.

As noted in the background section, for large software projects, there can be multiple software developers writing source code for a given software program. It can be difficult for a given software developer to know whether an error that is occurring during testing resulted from the code he wrote, the code he just changed, or from the code written by one or more of the other developers. In one implementation, techniques are described for prioritizing failures that are reported to developers and/or other users from the result of testing. The failures are compared with historical failures and then prioritized so that the user knows which failures he should focus on more than the others. The failures are then reported in an order of priority. The failures listed highest in priority are more likely caused by something that was just changed with the current set of changes being tested or from that developer's prior changes (as opposed to another developer's changes).

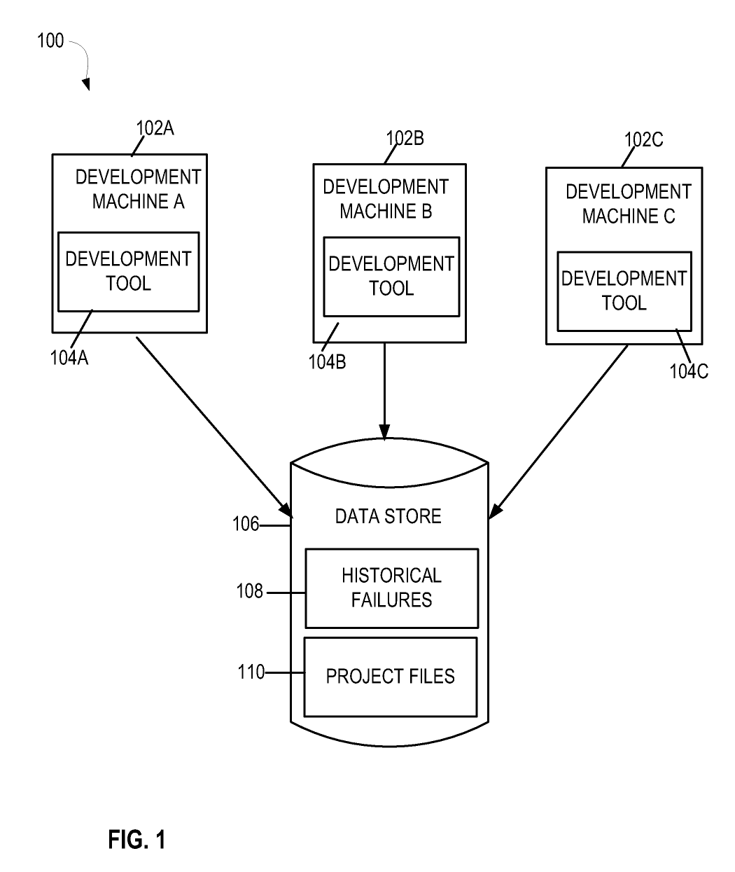

FIG. 1 is a diagrammatic view of a trend based test failure prioritization system 100 of one implementation. Multiple software developers can work together on the same software development project. Each developer can use a development machine (102A, 102B, and 102C) with one or more software development tools (104A, 104B, and 104C). Software development tools (104A, 104B, and 104C) are used to make changes to the software development project. Each developer can save his changes to the software development project to a central data store 106 which stores the project files 110. The project files 110 can include the source code files that are modified by the developers, and/or other related files needed for compiling and/or using the software development project. By storing project files 110 in the central data store 106 in a source code repository, changes that are made to the software development project by one developer can be accessed by the other developers and users too. This central source code repository also makes it easier to track changes that are made to the software development project over time.

When a given developer is ready to test changes he has just made to the software development project, he can run a series of automated or manual tests to confirm that the changes operate as expected. Any failures that occur during the automated or manual testing are stored in a data store 106 of historical failures 108. In the example shown in FIG. 1, the same central data store 106 is used to store the historical failures 108 and the project files 110. In other implementations, historical failures 108 and project files 110 can be stored on separate data stores and/or computers in one of numerous variations as would occur to one in the computer software art. Just one data store is illustrated for the sake of simplicity.

In one implementation, the modified software development project must be tested before the developer or other user is even allowed to check in his latest changes into the central data store 106 for publication to other users. In another implementation, the tests can be run after the developer or other user has checked in his latest changes into the central data store for publication to other users. Once the tests are run, if any failures are identified, then the data store 106 is consulted to retrieve any historical failures 108 that are similar to or the same as the current failure. An analysis process is performed to categorize any current failures as new failures or old failures, and prioritize the failures.

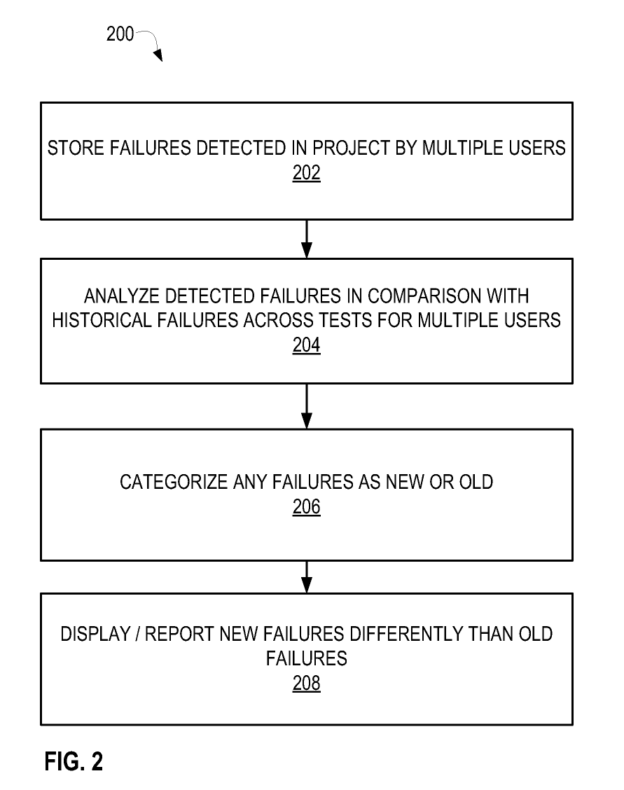

The failure results are then reported or otherwise displayed to the user based upon the results of the prioritization. For example, new failures can be shown with a higher priority than old failures. As another example, failures caused by changes of the current user can be shown with a higher priority than failures caused by other users. In one implementation, the prioritized test failure results are emailed to one or more users, such as after an automated testing tool finishes the testing. In such an implementation, the automated testing tool can be responsible for sending the email or other notification to any users that requested notice of the prioritized test results. In another implementation, the failure results can be accessed using an interactive testing tool or other tool that can display a test failure report. These steps for analyzing historical data and prioritizing failures are described in further detail in FIGS. 2-4, which are discussed next.

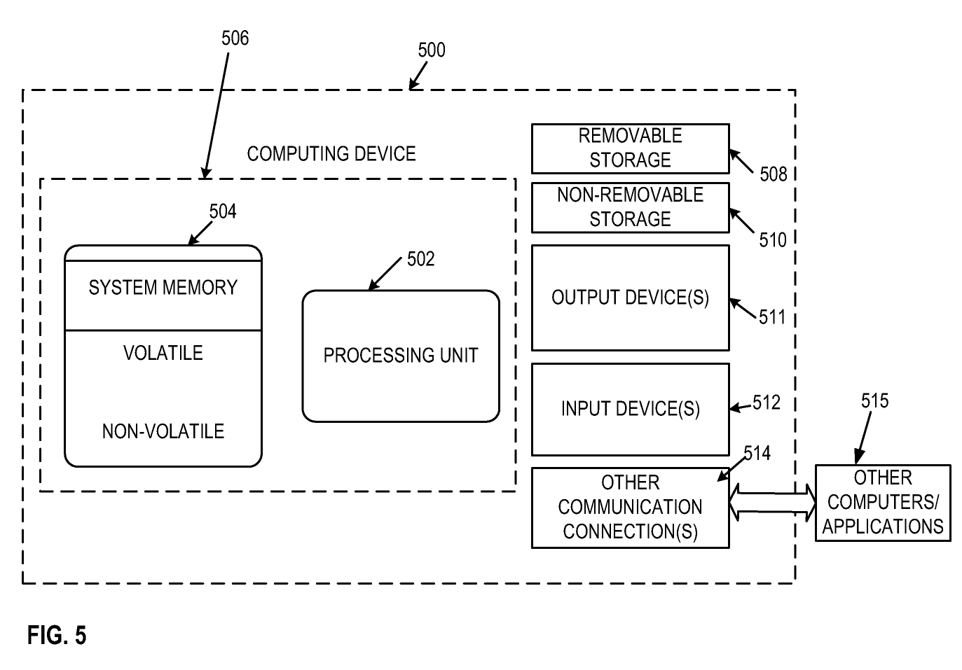

Turning now to FIGS. 2-4, the stages for implementing one or more implementations of trend based test failure prioritization system 100 are described in further detail. In some implementations, the processes of FIG. 2-4 are at least partially implemented in the operating logic of computing device 500 (of FIG. 5).

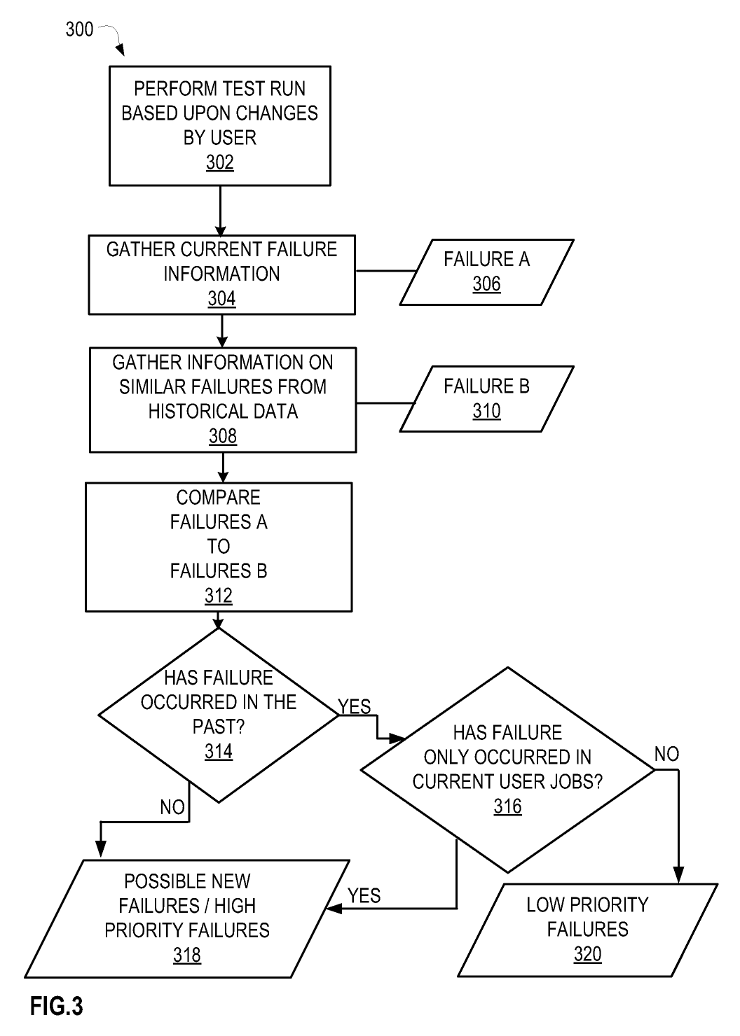

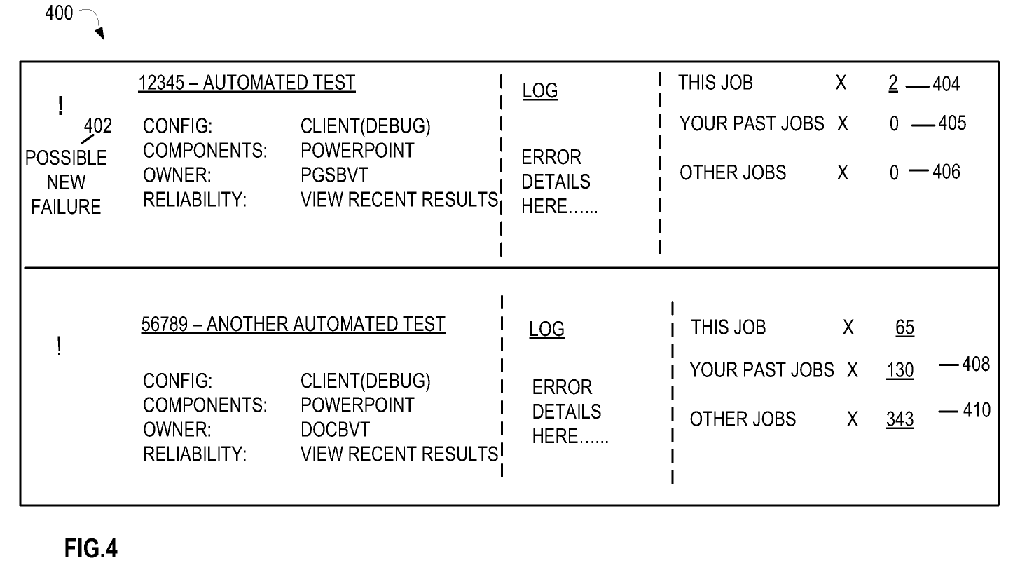

FIG. 2 is a high level process flow diagram 200 for one implementation illustrating the stages involved in reporting new failures differently than old failures. Failures detected from test runs of the software development project from multiple users are stored over a period of time in a data store (stage 202). When failures are detected from the current test run, the data store of historical failures is consulted (stage 204). Any detected failures are analyzed in comparison with historical failures for the project across multiple users (stage 204). Any failures discovered during this test run for the current user are then categorized as new or old (stage 206). New failures are displayed and/or reported differently than old failures (stage 208), such as with new failures being visually indicated or listed as a higher priority than older failures. These steps are described in further detail in FIGS. 3-4.

FIG. 3 is a process flow diagram 300 for one implementation illustrating the stages involved in prioritizing the way failures are reported based upon multiple criteria. A test run is performed based upon changes made by a current user (stage 302). Current failure information is gathered (stage 304), such as for failure A (stage 306). Information is gathered from the same or similar failures by consulting the historical data store (stage 308). In the example shown in FIG. 3, information is gathered regarding historical failure B (stage 310), which was determined to be similar to failure A.

Similar failures can be determined in one of various ways, such as by performing a string comparison to determine that a given failure only differs from another failure by a certain number of characters, and thus they should be considered similar. Another technique for determining whether two failures are similar can be by consulting a database that contains an index of failures that are known to be similar to each other. Other techniques for determining that failures are similar can also be used. Once the historical failures have been identified that are the same or similar to any current failures, then the failures can be categorized in priority.

Failure A is compared to failure B (stage 312). If the failure has not occurred in the past (decision point 314), then the failure is categorized as a possible new failure/high priority failure (stage 318). If the failure has occurred in the past (decision point 314), and the failure has only occurred in the current user's jobs (decision point 316), then the failure is categorized as a possible new failure/high priority failure (stage 318). If the failure has occurred in the past (decision point 314), and the failure has occurred in other user's jobs (decision point 316), then the failure is categorized as a lower priority failure (stage 320).

The result of this process is that failures are categorized into three groupings of failures. The first priority grouping includes failures that have not occurred in past test runs before (i.e. that are brand new failures resulting from the current changes). The second priority grouping includes failures that have occurred in past automated test runs for the current user, but not other users. The third priority grouping includes failures that have occurred in past test runs for other users. In other implementations, a different number of categories and/or logic can be used to group the failures in a priority order. These three are just included as one non-limiting example to illustrate how different levels of priority can be assigned based upon comparison of the current failure to historical trends. Furthermore, the process described in FIG. 3 can be utilized with more failures than just the two (Failure A and Failure B) described for the sake of illustration.

FIG. 4 is a simulated screen 400 for one implementation that illustrates the reporting of new failures differently than old failures. In the example shown, a visual indicator 402 is used to indicate that the first failure in the list is a possible new failure because it has only occurred in the current job of the current user (404). This failure has never occurred before in this user's past jobs (405), nor has it occurred in the past jobs of other users (406). The second failure in the list is listed with a lower priority since it has occurred in this user's jobs in the past (408), as well as in the jobs of other users (410). In one implementation, by sorting the more important failures to the top of the list, the user can focus on the problems that he introduced with his recent changes being tested, and not those failures that have been around and are caused by something or someone else.

As shown in FIG. 5, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 5 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for utilizing historical software execution failures from prior tests to prioritize how failures are reported in later tests comprising the steps of:
after a user changes a software development project, running one or more tests to detect failures during execution of the tests;
analyzing any detected failures in comparison with historical failures for the software development project across tests run for multiple users;
categorizing any detected failures as new or old; and
reporting new failures with a different emphasis than old failures.

2. The method of claim 1, wherein the historical failures are stored in a central data store accessible to the multiple users.

3. The method of claim 1, wherein new failures are reported in a list of failures with a higher priority than old failures.

4. The method of claim 1, wherein old failures introduced by the user are reported in a list of failures with a higher priority than old failures of other users.

5. The method of claim 1, wherein new failures are displayed with a visual indicator.

6. The method of claim 1, wherein the reporting step is performed by emailing a test failure report.

7. The method of claim 1, wherein the reporting step is performed by displaying a test failure report in an interactive test tool.

8. The method of claim 1, wherein the one or more tests are performed before the user checks in source code for the software development project to a central source code repository.

9. The method of claim 1, wherein the one or more tests are executed by an automated testing tool.

10. The method of claim 9, wherein the automated testing tool is responsible for performing the reporting step.

11. A method for prioritizing test failures based on analysis of historical failures across multiple users comprising the steps of:
gathering current failure information from one or more tests of a software development application for a current user;
gathering historical failure information from failures occurring in past test runs;
comparing current failure information to historical failure information to determine if any failures have occurred in past test runs; and
reporting any failures that have not occurred in past test runs as higher priority than any failures that have occurred in past test runs.

12. The method of claim 11, wherein historical failure information is gathered by accessing a data store of historical failures.

13. The method of claim 11, further comprising the steps of:
reporting any failures that have occurred in past test runs for the current user as higher priority than any failures that have occurred in past test runs for other users.

14. The method of claim 11, wherein the reporting step is performed by emailing a test failure report to one or more users.

15. The method of claim 11, wherein the reporting step is performed by displaying a test failure report in an interactive test tool.

16. The method of claim 11, wherein new failures are displayed with a visual indicator.

17. The method of claim 11, wherein the one or more tests are executed by an automated testing tool.

18. The method of claim 17, wherein the automated testing tool is responsible for performing the reporting step.

19. A computer-readable medium having computer-executable instructions for causing a computer to perform steps comprising:
gathering current failure information from one or more automated tests of a software development application for a current user;
gathering historical failure information from failures occurring in past automated test runs of the software development application for all users;
comparing current failure information to historical failure information to determine if any failures have occurred in past test runs;
reporting any failures that have not occurred in past automated test runs in a first priority grouping of failures;
reporting any failures that have occurred in past automated test runs for the current user in a second priority grouping of failures; and
reporting any failures that have occurred in past automated test runs for other users in a third priority grouping of failures.

20. The computer-readable medium of claim 19, wherein the historical failure information is stored in a central data store.
